(19) United States
(12) Patent Application Publication
(10) Pub. No.: US 2026/0087650 A1
(43) Pub. Date: Mar. 26, 2026

(54) Systems and Methods for Barycentric Motion Vector Estimation

(71) Applicant: Apple Inc., Cupertino, CA (US)

(72) Inventors: Shereef Shehata, San Ramon, CA (US); Jim C. Chou, San Jose, CA (US)

(21) Appl. No.: 18/967,309

(22) Filed: Dec. 3, 2024

Related U.S. Application Data
(60) Provisional application No. 63/699,711, filed on Sep. 26, 2024.

(51) Int. Cl. G06T 7/246; G06T 3/4007

(52) U.S. Cl. CPC G06T 7/251; G06T 3/4007

(57) ABSTRACT

Embodiments described herein may employ barycentric motion vector estimation to reduce image artifacts along edges of the content. An electronic device may include motion vector estimation circuitry to perform barycentric interpolation. The barycentric interpolation may involve a triangular interpolation method to interpolate at a first triangle and a second triangle. The motion vector estimation circuitry may apply a first weighting factor to the first set of interpolated values based on a first strength of an edge of the first triangle and a second weighting factor to the second set of interpolated values based on a second strength of an edge of the second triangle. The motion vector estimation circuitry may then output a set of motion vectors based on the weighting factors, the first set of interpolated values, and the second set of interpolated values.

### CROSS-REFERENCE TO RELATED APPLICATIONS

This application claims priority to U.S. Provisional Application No. 63/699,711, filed Sep. 26, 2024, which is incorporated by reference in its entirety.

### BACKGROUND

The present disclosure relates generally to performing barycentric (e.g., edge-adaptive) motion vector estimation to reduce image artifacts (e.g., jagged edges).

In video encoding, motion vectors, which correspond to the movement of content from one frame to another, are commonly used to efficiently compress and encode data, such as image and video data. These motion vectors enable a reduction of redundant information by predicting how elements within a scene may change over time. However, inaccuracies in motion vector estimation may result in image artifacts, particularly at edges of the content. For example, the image artifacts may include jagged edges (e.g., stair-stepping effects), leading to visual artifacts that impact visual quality. As such, the visual artifacts may affect a viewer's experience.

### SUMMARY

Systems and methods described herein may employ barycentric motion vector estimation to reduce aliasing artifacts along the edges of the content. An electronic device may include motion vector estimation circuitry to perform barycentric interpolation. The barycentric interpolation may involve a triangular interpolation method to interpolate motion vectors between a first point, a second point, a third point, and/or a fourth point. For a given spatial point, interpolation may occur at an intersection of two triangles out of four triangles within the first point, the second point, the third point, and the fourth point. For example, the four triangles may include a top right triangle, a bottom left triangle, a top left triangle, and a bottom right triangle.

The motion vector estimation circuitry may perform barycentric interpolation by determining a first set of interpolated values for a first triangle (e.g., first intersecting triangle) and a second set of interpolated values for a second triangle (e.g., second intersecting triangle). The motion vector estimation circuitry may determine a first strength of a first edge of the first triangle and a second strength of a second edge of the second triangle. Further, the motion vector estimation circuitry may apply a weighting factor to the first set of interpolated values based on the first strength and a weighting factor to the second set of interpolated values based on the second strength. The motion vector estimation circuitry may output a set of motion vectors based on the weighting factors, the first set of interpolated values, and the second set of interpolated values.

### BRIEF DESCRIPTION OF THE DRAWINGS

Various aspects of this disclosure may be better understood upon reading the following detailed description and upon reference to the drawings in which:

FIG. 1 is a block diagram of an electronic device, according to embodiments of the present disclosure;

FIG. 2 is a front view of a handheld device representing an example of the electronic device of FIG. 1, according to embodiments of the present disclosure;

FIG. 3 is a front view of another handheld device representing another example of the electronic device of FIG. 1, according to embodiments of the present disclosure;

FIG. 4 is a perspective view of a notebook computer representing an example of the electronic device of FIG. 1, according to embodiments of the present disclosure;

FIG. 5 illustrates front and side views of a wearable electronic device representing another example of the electronic device of FIG. 1, according to embodiments of the present disclosure;

FIG. 6 is a block diagram of a portion of the electronic device of FIG. 1, including a video encoding system, according to embodiments of the present disclosure;

FIG. 7 is an example illustration of image content depicting image artifacts that are less visible on a display of the electronic device of FIG. 1 after pixel adjustment, according to embodiments of the present disclosure;

FIG. 8 is an example illustration of barycentric interpolation for a top-right triangle, according to embodiments of the present disclosure;

FIG. 9 is an example illustration of barycentric interpolation for a bottom-left triangle, according to embodiments of the present disclosure;

FIG. 10 is an example illustration of barycentric interpolation for a top-left triangle, according to embodiments of the present disclosure;

FIG. 11 is an example illustration of barycentric interpolation for a bottom-right triangle, according to embodiments of the present disclosure;

FIG. 12 is an example illustration of edge-adaptive barycentric interpolation for an intersection of a first triangle and a second triangle, according to embodiments of the present disclosure;

FIG. 13 is an example illustration of edge-adaptive barycentric interpolation for an intersection of the second triangle and a third triangle, according to embodiments of the present disclosure;

FIG. 14 is an example illustration of edge-adaptive barycentric interpolation for an intersection of the first triangle and a fourth triangle, according to embodiments of the present disclosure;

FIG. 15 is an example illustration of edge-adaptive barycentric interpolation for an intersection of the third triangle and the fourth triangle, according to embodiments of the present disclosure; and

FIG. 16 is a flowchart of a method for outputting a set of motion vectors based on weighing factors, a first set of barycentric interpolated values, and a second set of barycentric interpolated values, according to embodiments of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

Embodiments described herein generally relate to performing barycentric motion vector estimation (e.g., edge-adaptive barycentric motion vector estimation) to reduce image artifacts (e.g., jagged edges). For example, an electronic device may employ motion vector estimation circuitry to perform barycentric motion vector estimation to reduce aliasing artifacts along the edges of the content. Barycentric interpolation may involve a triangular interpolation method between a first point, a second point, a third point, and/or a fourth point. As an example, the motion vector estimation circuitry may perform barycentric interpolation by determining a first set of interpolated values for a first triangle (e.g., first intersecting triangle) and a second set of interpolated values for a second triangle (e.g., second intersecting triangle) at a particular spatial location. The motion vector estimation circuitry may determine a first strength of a first edge of the first triangle and a second strength of a second edge of the second triangle. The motion vector estimation circuitry may apply a weighting factor to the first set of interpolated values based on the first strength and the second set of interpolated values based on the second strength. In this manner, the motion vector estimation circuitry may output a set of motion vectors based on the weighting factor, the first set of interpolated values, and the second set of interpolated values.

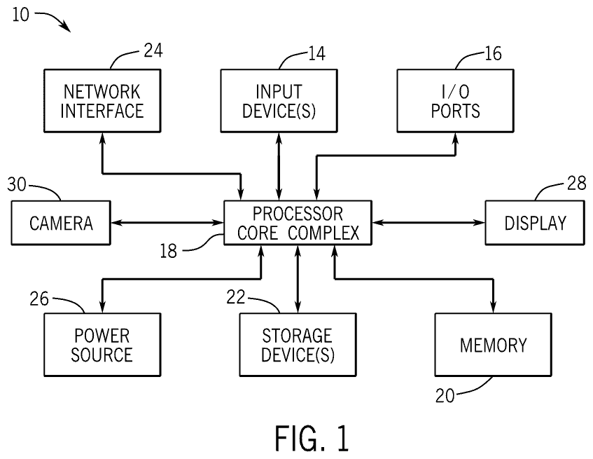

FIG. 1 is a block diagram of an electronic device 10, according to embodiments of the present disclosure. As is described in more detail below, the electronic device 10 may be any suitable electronic device, such as a computer, a mobile phone, a portable media device, a tablet, a television, a virtual-reality headset, a wearable device such as a watch, a vehicle dashboard, or the like. Thus, it should be noted that FIG. 1 is merely one example of a particular implementation and is intended to illustrate the types of components that may be present in an electronic device 10.

The electronic device 10 includes one or more input devices 14, one or more input/output (I/O) ports 16, a processor core complex 18 having one or more processing circuitry(s) or processing circuitry cores, local memory 20, a main memory storage device 22, a network interface 24, a power source 26 (e.g., power supply), an electronic display 28, and a camera 30. The various components described in FIG. 1 may include hardware elements (e.g., circuitry), software elements (e.g., a tangible, non-transitory computer-readable medium storing executable instructions), or a combination of both hardware and software elements. It should be noted that the various depicted components may be combined into fewer components or separated into additional components. For example, the local memory 20 and the main memory storage device 22 may be included in a single component.

In some embodiments, the electronic device 10 may include two or more processor core complexes 18. The embodiments discussed herein may be associated with and/or similarly applicable to embodiments of the electronic device 10 including a single processor core complex 18 and embodiments of the electronic device 10 including two or more processor core complexes 18. For example, one or more of the processor core complexes 18 may include multiple cores including one or more processors, one or more controller, and/or one or more state machine circuits. Each of the two or more processor core complexes 18 may perform some functions or provide at least a portion of control signals and/or instructions discussed herein. In specific embodiments, some of the two or more processor core complexes 18 may be coupled together and may perform certain functions discussed herein individually or in collaboration with each other.

The processor core complex 18 is operably coupled with local memory 20 and the main memory storage device 22. Thus, the processor core complex 18 may execute instructions stored in local memory 20 and/or the main memory storage device 22 to perform operations, such as generating or transmitting image data to display on the electronic display 28 and/or receiving image data generated by the camera 30. As such, the processor core complex 18 may include one or more processors, one or more general purpose microprocessors, one or more application specific integrated circuits (ASICs), one or more field programmable gate arrays (FPGAs), or any combination thereof. In some embodiments, a system on a chip (SoC) may include the processor core complex 18, among other things.

In addition to program instructions, the local memory 20 or the main memory storage device 22 may store data to be processed by the processor core complex 18. Thus, the local memory 20 and/or the main memory storage device 22 may include one or more tangible, non-transitory, computer-readable media. For example, the local memory 20 may include random access memory (RAM) and the main memory storage device 22 may include read-only memory (ROM), rewritable non-volatile memory such as flash memory, hard drives, optical discs, or the like.

The network interface 24 may communicate data with another electronic device or a network. For example, the network interface 24 (e.g., a radio frequency system) may enable the electronic device 10 to communicatively couple to a personal area network (PAN), such as a Bluetooth network, a local area network (LAN), such as an 802.11x Wi-Fi network, or a wide area network (WAN), such as a 4G, Long-Term Evolution (LTE), or 5G cellular network.

The power source 26 may provide electrical power to one or more components in the electronic device 10, such as the processor core complex 18, the electronic display 28, and/or the camera 30. For example, the power source 26 may include a power supply rail and/or a ground terminal coupled to the one or more components in the electronic device 10, such as the processor core complex 18, the electronic display 28, and/or the camera 30 to provide the electrical power. Thus, the power source 26 may include any suitable source of energy, such as a rechargeable lithium polymer (Li-poly) battery or an alternating current (AC) power converter.

The processor core complex 18 may generate and/or output (e.g., provide) raw data or image data. For example, the display 28 may receive and/or display the raw data or the image data. The I/O ports 16 may enable the electronic device 10 to interface with other electronic devices. For example, when a portable storage device is connected, the I/O port 16 may enable the processor core complex 18 to communicate data with the portable storage device. The input devices 14 may enable user interaction with the electronic device 10, for example, by receiving user inputs via a button, a keyboard, a mouse, a trackpad, or the like. The input device 14 may include touch-sensing components in the electronic display 28. The touch sensing components may receive user inputs by detecting occurrence or position of an object touching the surface of the electronic display 28.

The electronic display 28 may include driver circuitry (e.g., display driver circuitry) and/or a display panel including pixel circuitry with an array of display pixels. Moreover, the driver circuitry may include various circuitry to provide one or more stable positive and/or negative supply voltages, such as the power supply rail and/or the ground terminal. Image data for display on the electronic display 28 may be generated by an image source, such as the processor core complex 18, a graphics processing unit (GPU), or an image sensor. Additionally, in some embodiments, image data may be received from another electronic device 10, for example, via the network interface 24 and/or an I/O port 16. Similarly, the electronic display 28 may display frames based on image data generated by the processor core complex 18, or the electronic display 28 may display frames based on image data received via the network interface 24, an input device, or an I/O port 16.

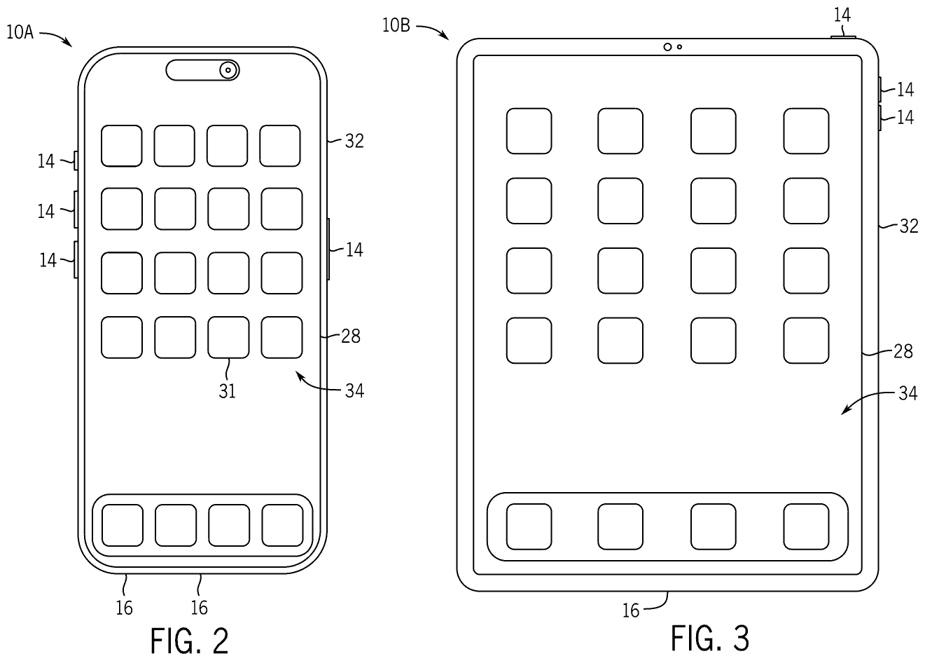

The electronic device 10 may be any suitable electronic device. To help illustrate, an example of the electronic device 10, a handheld device 10A, is shown in FIG. 2. The handheld device 10A may be a portable phone, a media player, a personal data organizer, a handheld game platform, or the like. For illustrative purposes, the handheld device 10A may be a smart phone, such as an IPHONE® model available from Apple Inc.

The handheld device 10A includes an enclosure 32 (e.g., housing). The enclosure 32 may protect interior components from physical damage or shield them from electromagnetic interference, such as by surrounding the electronic display 28. The electronic display 28 may display a graphical user interface (GUI) 34 having an array of icons. When an icon 31 is selected either by an input device 14 or a touch-sensing component of the electronic display 28, an application program may launch.

The input devices 14 may be accessed through openings in the enclosure 32. The input devices 14 may enable a user to interact with the handheld device 10A. For example, the input devices 14 may enable the user to activate or deactivate the handheld device 10A, navigate a user interface to a home screen, navigate a user interface to a user-configurable application screen, activate a voice-recognition feature, provide volume control, or toggle between vibrate and ring modes.

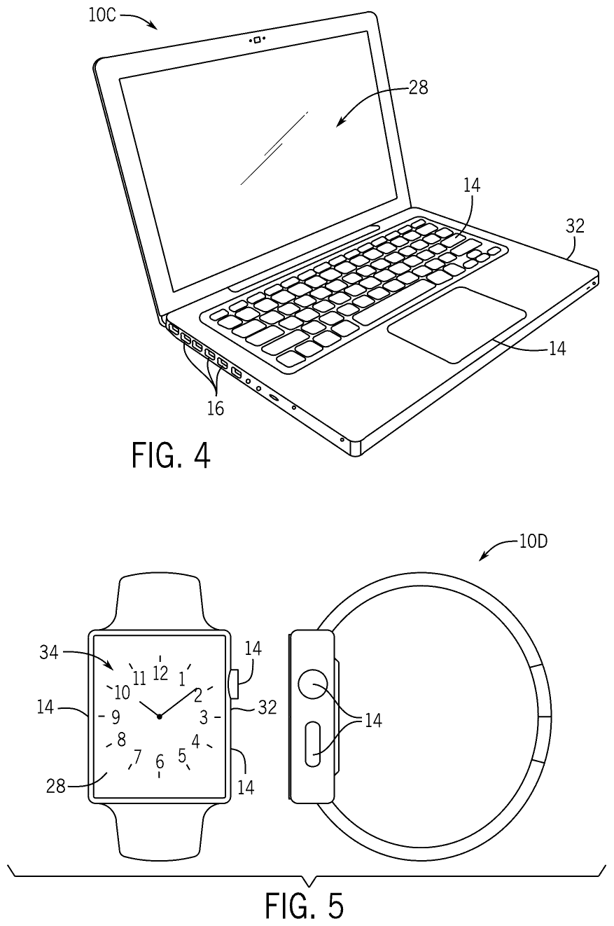

Another example of a suitable electronic device 10, specifically a tablet device 10B, is shown in FIG. 3. The tablet device 10B may be an IPAD® model available from Apple Inc. A further example of a suitable electronic device 10, specifically a computer 10C, is shown in FIG. 4. For illustrative purposes, the computer 10C may be a MACBOOK® or IMAC® model available from Apple Inc. Another example of a suitable electronic device 10, specifically a watch 10D, is shown in FIG. 5. For illustrative purposes, the watch 10D may be an APPLE WATCH® model available from Apple Inc.

As depicted, the tablet device 10B, the computer 10C, and the watch 10D each also includes an electronic display 28, input devices 14, I/O ports 16, and an enclosure 32. The electronic display 28 may display a GUI 34. As shown in FIG. 5, the GUI 34 may show a visualization of a clock. When the visualization is selected either by the input device 14 or a touch-sensing component of the electronic display 28, an application program may launch, such as to transition the GUI 34 to presenting the icons 31 discussed with respect to FIGS. 2 and 3.

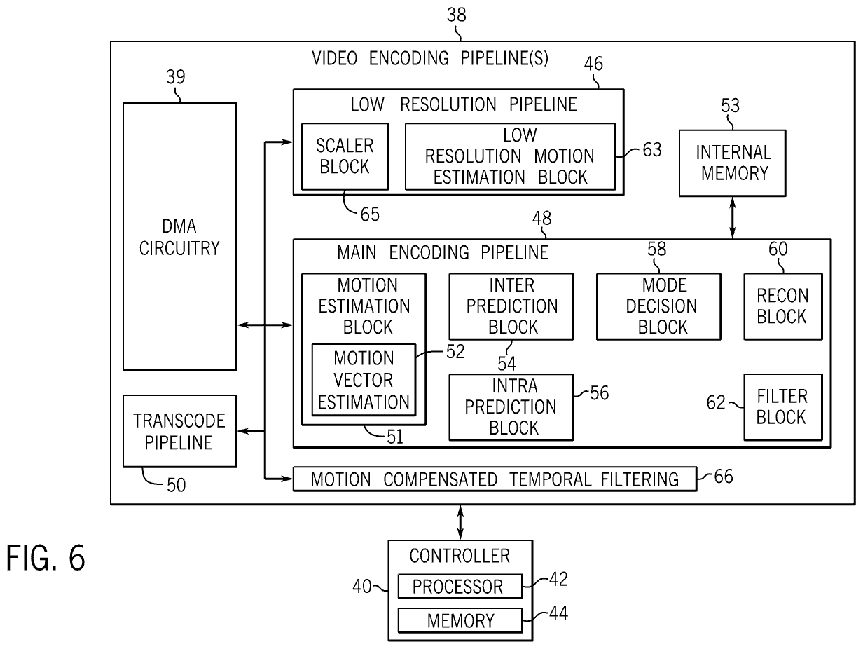

An example of a portion of an electronic device 10, which includes a video encoding system 38, is shown in FIG. 6. The video encoding system 38 may be implemented via circuitry, for example, packaged as a system-on-chip (SoC), such as included in the processor core complex 18 and/or separate image processing circuitry of the electronic device 10. In an embodiment, the image processing circuitry of the electronic device 10 may be a part of the camera 30 or the processor core complex 18. Additionally or alternatively, the video encoding system 38 may be implemented in one or more other processing units, other processing circuitry, or any combination thereof.

The video encoding system 38 may be communicatively coupled to a controller 40. The controller 40 may generally control operation of the video encoding system 38. Although depicted as a single controller 40, in other embodiments, one or more separate controllers 40 may be used to control operation of the video encoding system 38. Additionally, in some embodiments, the controller 40 may be implemented in the video encoding system 38, for example, as a dedicated video encoding controller.

The controller 40 may include a controller processor 42 and controller memory 44. In some embodiments, the controller processor 42 may execute instructions and/or process data stored in the controller memory 44 to control operation of the video encoding system 38. In other embodiments, the controller processor 42 may be hardwired with instructions that control operation of the video encoding system 38 (e.g., as a finite state machine). Additionally, in some embodiments, the controller processor 42 may be included in the processor core complex 18, the image processing circuitry, and/or separate processing circuitry (e.g., in the electronic display 28), and the controller memory 44 may be included in local memory 21, main memory storage device 22, and/or a separate, tangible, non-transitory computer-readable medium (e.g., in the electronic display 28).

The video encoding system 38 may include direct memory access (DMA) circuitry 39. In some embodiments, the DMA circuitry 39 may communicatively couple the video encoding system 38 to an image sensor, such as external memory that stores source image data, for example, generated by the image sensor or received via the network interface 24 or the I/O ports 16.

To facilitate generating encoded image data, the video encoding system 38 may include multiple parallel pipelines. For example, in the depicted embodiment, the video encoding system 38 includes a low-resolution pipeline 46, a main encoding pipeline 48, and a transcode pipeline 50. The main encoding pipeline 48 may encode source image data using prediction techniques (e.g., inter prediction techniques or intra prediction techniques), and the transcode pipeline 50 may subsequently entropy encode syntax elements that indicate encoding parameters (e.g., quantization coefficient, inter prediction mode, and/or intra prediction mode) used to prediction encode the image data.

To facilitate prediction encoding source image data, the main encoding pipeline 48 may perform various functions. To simplify discussion, the functions are divided between various blocks (e.g., circuitry or modules) in the main encoding pipeline 48. In the depicted embodiment, the main encoding pipeline 48 includes a motion estimation block 51, an inter prediction block 54, an intra prediction block 56, a mode decision block 58, a reconstruction block 60, and a filter block 62.

The motion estimation block 51 is communicatively coupled to the DMA circuitry 39. In this manner, the motion estimation block 51 may receive source image data via the DMA circuitry 39, which may include a luma component (e.g., Y) and two chroma components (e.g., Cr and Cb). In some embodiments, the motion estimation block 51 may process one coding unit, including one luma coding block and two chroma coding blocks, at a time. As used herein a “luma coding block” is intended to describe the luma component of a coding unit and a “chroma coding block” is intended to describe a chroma component of a coding unit.

A luma coding block may be the same resolution as the coding unit. On the other hand, the chroma coding blocks may vary in resolution based on chroma sampling format. For example, using a 4:4:4 sampling format, the chroma coding blocks may be the same resolution as the coding unit. However, the chroma coding blocks may be half (e.g., half resolution in the horizontal direction) the resolution of the coding unit when a 4:2:2 sampling format is used and a quarter (e.g., half resolution in the horizontal direction and half resolution in the vertical direction) the resolution of the coding unit when a 4:2:0 sampling format is used.

As described above, a coding unit may include one or more prediction units, which may each be encoded using the same prediction technique, but different prediction modes. Each prediction unit may include one luma prediction block and two chroma prediction blocks. As used herein a “luma prediction block” is intended to describe the luma component of a prediction unit and a “chroma prediction block” is intended to describe a chroma component of the prediction unit. In some embodiments, the luma prediction block may be the same resolution as the prediction unit. On the other hand, similar to the chroma coding blocks, the chroma prediction blocks may vary in resolution based on chroma sampling format.

Based at least in part on the one or more luma prediction blocks, the motion estimation block 51 may determine candidate inter prediction modes that can be used to encode a prediction unit. An inter prediction mode may include a motion vector and a reference index to indicate location (e.g., spatial position and temporal position) of a reference sample relative to a prediction unit. More specifically, the reference index may indicate display order of a reference image frame corresponding with the reference sample relative to a current image frame corresponding with the prediction unit. Additionally, the motion vector may indicate position of the reference sample in the reference image frame relative to position of the prediction unit in the current image frame.

To determine a candidate inter prediction mode, the motion estimation block 51 may search reconstructed luma image data, which may be previously generated by the reconstruction block 60 and stored in internal memory 53 (e.g., reference memory) of the video encoding system 38. For example, the motion estimation block 51 may determine a reference sample for a prediction unit by comparing its luma prediction block to the luma of reconstructed image data. In some embodiments, the motion estimation block 51 may determine how closely a prediction unit and a reference sample match based on a match metric. In some embodiments, the match metric may be the sum of absolute difference (SAD) between a luma prediction block of the prediction unit and luma of the reference sample. Additionally or alternatively, the match metric may be the sum of absolute transformed difference (SATD) between the luma prediction block and luma of the reference sample. When the match metric is above a match threshold, the motion estimation block 51 may determine that the reference sample and the prediction unit do not closely match. On the other hand, when the match metric is below the match threshold, the motion estimation block 51 may determine that the reference sample and the prediction unit are similar.

After a reference sample that sufficiently matches the prediction unit is determined, the motion estimation block 51 may determine location of the reference sample relative to the prediction unit. For example, the motion estimation block 51 may determine a reference index to indicate a reference image frame, which contains the reference sample, relative to a current image frame, which contains the prediction unit. Additionally, the motion estimation block 51 may determine a motion vector to indicate position of the reference sample in the reference frame relative to position of the prediction unit in the current frame. In some embodiments, the motion vector may be expressed as (mvX, mvY), where mvX is horizontal offset and mvY is a vertical offset between the prediction unit and the reference sample. The values of the horizontal and vertical offsets may also be referred to as x-components and y-components, respectively.

In this manner, the motion estimation block 51 may determine candidate inter prediction modes (e.g., reference index and motion vector) for one or more prediction units in the coding unit. The motion estimation block 51 may then input candidate inter prediction modes to the inter prediction block 54. Based at least in part on the candidate inter prediction modes, the inter prediction block 54 may determine luma prediction samples (e.g., predictions of a prediction unit). As will be described in further detail below, the motion estimation block 51 may also include motion vector estimation circuitry 52 (e.g., motion vector interpolation circuitry) to perform edge-adaptive barycentric motion vector estimation to reduce image artifacts, such as jagged edges, in image content.

The inter prediction block 54 may determine a luma prediction sample by applying motion compensation to a reference sample indicated by a candidate inter prediction mode. For example, the inter prediction block 54 may apply motion compensation by determining luma of the reference sample at fractional (e.g., quarter or half) pixel positions. The inter prediction block 54 may then input the luma prediction sample and corresponding candidate inter prediction mode to the mode decision block 58 for consideration. In some embodiments, the inter prediction block 54 may sort the candidate inter prediction modes based on associated mode cost and input only a specific number to the mode decision block 58.

The mode decision block 58 may also consider one or more candidate intra predictions modes and corresponding luma prediction samples output by the intra prediction block 56. The main encoding pipeline 48 may be capable of implementing multiple (e.g., 13, 17, 25, 29, 35, 38, or 43) different intra prediction modes to generate luma prediction samples based on adjacent pixel image data. Thus, in some embodiments, the intra prediction block 56 may determine a candidate intra prediction mode and corresponding luma prediction sample for a prediction unit based at least in part on luma of reconstructed image data for adjacent (e.g., top, top right, left, or bottom left) pixel values, which may be generated by the reconstruction block 60.

For example, utilizing a vertical prediction mode, the intra prediction block 56 may set each column of a luma prediction sample equal to reconstructed luma of a pixel directly above the column. Additionally, utilizing a DC prediction mode, the intra prediction block 56 may set a luma prediction sample equal to an average of reconstructed luma of pixel values adjacent the prediction sample. The intra prediction block 56 may then input candidate intra prediction modes and corresponding luma prediction samples to the mode decision block 58 for consideration. In some embodiments, the intra prediction block 56 may sort the candidate intra prediction modes based on associated mode cost and input only a specific number to the mode decision block 58.

The mode decision block 58 may determine encoding parameters to be used to encode the source image data (e.g., a coding unit). In some embodiments, the encoding parameters for a coding unit may include prediction technique (e.g., intra prediction techniques or inter prediction techniques) for the coding unit, number of prediction units in the coding unit, size of the prediction units, prediction mode (e.g., intra prediction modes or inter prediction modes) for each of the prediction units, number of transform units in the coding unit, size of the transform units, whether to split the coding unit into smaller coding units, or any combination thereof.

To facilitate determining the encoding parameters, the mode decision block 58 may determine whether the image frame is an I-frame, a P-frame, or a B-frame. In I-frames, source image data is encoded only by referencing other image data used to display the same image frame. Accordingly, when the image frame is an I-frame, the mode decision block 58 may determine that each coding unit in the image frame may be prediction encoded using intra prediction techniques.

On the other hand, in a P-frame or B-frame, source image data may be encoded by referencing image data used to display the same image frame and/or a different image frame. More specifically, in a P-frame, source image data may be encoding by referencing image data associated with a previously coded or transmitted image frame. Additionally, in a B-frame, source image data may be encoded by referencing image data used to code two previous image frames. More specifically, with a B-frame, a prediction sample may be generated based on prediction samples from two previously coded frames; the two frames may be different from one another or the same as one another. Accordingly, when the image frame is a P-frame or a B-frame, the mode decision block 58 may determine that each coding unit in the image frame may be prediction encoded using either intra techniques or inter techniques.

Although using the same prediction technique, the configuration of luma prediction blocks in a coding unit may vary. For example, the coding unit may include a variable number of luma prediction blocks at variable locations within the coding unit, which each uses a different prediction mode. As used herein, a “prediction mode configuration” is intended to describe the number, size, location, and prediction mode of luma prediction blocks in a coding unit. Thus, the mode decision block 58 may determine a candidate inter prediction mode configuration using one or more of the candidate inter prediction modes received from the inter prediction block 54. Additionally, the mode decision block 58 may determine a candidate intra prediction mode configuration using one or more of the candidate intra prediction modes received from the intra prediction block 56.

Since a coding unit may utilize the same prediction technique, the mode decision block 58 may determine prediction technique for the coding unit by comparing rate-distortion metrics (e.g., costs) associated with the candidate prediction mode configurations and/or a skip mode. In some embodiments, the rate-distortion metric may be determined by summing a first product obtained by multiplying an estimated rate that indicates number of bits expected to be used to indicate encoding parameters and a first weighting factor for the estimated rate and a second product obtained by multiplying a distortion metric (e.g., sum of squared difference) resulting from the encoding parameters and a second weighting factor for the distortion metric. The first weighting factor may be a Lagrangian multiplier, and the first weighting factor may depend on a quantization parameter associated with image data being processed.

The distortion metric may indicate amount of distortion in decoded image data expected to be caused by implementing a prediction mode configuration. Accordingly, in some embodiments, the distortion metric may be a sum of squared difference (SSD) between a luma coding block (e.g., source image data) and reconstructed luma image data received from the reconstruction block 60. Additionally or alternatively, the distortion metric may be a sum of absolute transformed difference (SATD) between the luma coding block and reconstructed luma image data received from the reconstruction block 60.

In some embodiments, prediction residuals (e.g., differences between source image data and prediction sample) resulting in a coding unit may be transformed as one or more transform units. As used herein, a “transform unit” is intended to describe a sample within a coding unit that is transformed together. In some embodiments, a coding unit may include a single transform unit. In other embodiments, the coding unit may be divided into multiple transform units, which is each separately transformed.

Additionally, the estimated rate for an intra prediction mode configuration may include expected number of bits used to indicate intra prediction technique (e.g., coding unit overhead), expected number of bits used to indicate intra prediction mode, expected number of bits used to indicate a prediction residual (e.g., source image data-prediction sample), and expected number of bits used to indicate a transform unit split. On the other hand, the estimated rate for an inter prediction mode configuration may include expected number of bits used to indicate inter prediction technique, expected number of bits used to indicate a motion vector (e.g., motion vector difference), and expected number of bits used to indicate a transform unit split. Additionally, the estimated rate of the skip mode may include number of bits expected to be used to indicate the coding unit when prediction encoding is skipped.

The mode decision block 58 may select a prediction mode configuration or skip mode with the lowest associated rate-distortion metric for a coding unit. In this manner, the mode decision block 58 may determine encoding parameters for a coding unit, which may include prediction technique (e.g., intra prediction techniques or inter prediction techniques) for the coding unit, number of prediction units in the coding unit, size of the prediction units, prediction mode (e.g., intra prediction modes or inter prediction modes) for each of the prediction unit, number of transform units in the coding block, size of the transform units, whether to split the coding unit into smaller coding units, or any combination thereof.

To facilitate improving perceived image quality resulting from decoded image data, the main encoding pipeline 48 may mirror decoding of encoded image data. To facilitate, the mode decision block 58 may output the encoding parameters and/or luma prediction samples to the reconstruction block 60. Based on the encoding parameters and reconstructed image data associated with one or more adjacent blocks of image data, the reconstruction block 60 may reconstruct image data.

More specifically, the reconstruction block 60 may generate the luma component of reconstructed image data. In some embodiments, the reconstruction block 60 may generate reconstructed luma image data by subtracting the luma prediction sample from luma of the source image data to determine a luma prediction residual. The reconstruction block 60 may then divide the luma prediction residuals into luma transform blocks as determined by the mode decision block 58, perform a forward transform and quantization on each of the luma transform blocks, and perform an inverse transform and quantization on each of the luma transform blocks to determine a reconstructed luma prediction residual. The reconstruction block 60 may then add the reconstructed luma prediction residual to the luma prediction sample to determine reconstructed luma image data. As described above, the reconstructed luma image data may then be fed back for use in other blocks in the main encoding pipeline 48, for example, via storage in internal memory 53 of the main encoding pipeline 48. Additionally, the reconstructed luma image data may be output to the filter block 62.

The reconstruction block 60 may also generate both chroma components of reconstructed image data. In some embodiments, chroma reconstruction may be dependent on sampling format. For example, when luma and chroma are sampled at the same resolution (e.g., 4:4:4 sampling format), the reconstruction block 60 may utilize the same encoding parameters as used to reconstruct luma image data. In such embodiments, for each chroma component, the reconstruction block 60 may generate a chroma prediction sample by applying the prediction mode configuration determined by the mode decision block 58 to adjacent pixel image data.

The reconstruction block 60 may then subtract the chroma prediction sample from chroma of the source image data to determine a chroma prediction residual. Additionally, the reconstruction block 60 may divide the chroma prediction residual into chroma transform blocks as determined by the mode decision block 58, perform a forward transform and quantization on each of the chroma transform blocks, and perform an inverse transform and quantization on each of the chroma transform blocks to determine a reconstructed chroma prediction residual. The chroma reconstruction block may then add the reconstructed chroma prediction residual to the chroma prediction sample to determine reconstructed chroma image data, which may be input to the filter block 62.

However, in other embodiments, chroma sampling resolution may vary from luma sampling resolution, for example when a 4:2:2 or 4:2:0 sampling format is used. In such embodiments, encoding parameters determined by the mode decision block 58 may be scaled. For example, when the 4:2:2 sampling format is used, size of chroma prediction blocks may be scaled in half horizontally from the size of prediction units determined in the mode decision block 58. Additionally, when the 4:2:0 sampling format is used, size of chroma prediction blocks may be scaled in half vertically and horizontally from the size of prediction units determined in the mode decision block 58. In a similar manner, a motion vector determined by the mode decision block 58 may be scaled for use with chroma prediction blocks.

To improve quality of decoded image data, the filter block 62 may filter the reconstructed image data (e.g., reconstructed chroma image data and/or reconstructed luma image data). In some embodiments, the filter block 62 may perform deblocking and/or sample adaptive offset (SAO) functions. For example, the filter block 62 may perform deblocking on the reconstructed image data to reduce perceivability of blocking artifacts that may be introduced. Additionally, the filter block 62 may perform a sample adaptive offset function by adding offsets to portions of the reconstructed image data.

To enable decoding, encoding parameters used to generate encoded image data may be communicated to a decoding device. In some embodiments, the encoding parameters may include the encoding parameters determined by the mode decision block 58 (e.g., prediction unit configuration and/or transform unit configuration), encoding parameters used by the reconstruction block 60 (e.g., quantization coefficients), and encoding parameters used by the filter block 62. To facilitate communication, the encoding parameters may be expressed as syntax elements. For example, a first syntax element may indicate a prediction mode (e.g., inter prediction mode or intra prediction mode), a second syntax element may indicate a quantization coefficient, a third syntax element may indicate configuration of prediction units, and a fourth syntax element may indicate configuration of transform units.

The transcode pipeline 50 may then convert a bin stream, which is representative of syntax elements generated by the main encoding pipeline 48, to a bit stream with one or more syntax elements represented by a fractional number of bits. In some embodiments, the transcode pipeline 50 may compress bins from the bin stream into bits using arithmetic coding. To facilitate arithmetic coding, the transcode pipeline 50 may determine a context model for a bin, which indicates probability of the bin being a “1” or “0,” based on previous bins. Based on the probability of the bin, the transcode pipeline 50 may divide a range into two sub-ranges. The transcode pipeline 50 may then determine an encoded bit such that it falls within one of two sub-ranges to select the actual value of the bin. In this manner, multiple bins may be represented by a single bit, thereby improving encoding efficiency (e.g., reduction in size of source image data). After entropy encoding, the transcode pipeline 50, may transmit the encoded image data to an output for transmission, storage, and/or display.

Furthermore, the video encoding system 38 may be communicatively coupled to an output. In this manner, the video encoding system 38 may output encoded (e.g., compressed) image data to such an output, for example, for storage and/or transmission. Thus, in some embodiments, the local memory 20, the main memory storage device 22, the network interface 24, the I/O ports 16, the controller memory 44, or any combination thereof may serve as an output.

As described above, the duration provided for encoding image data may be limited, particularly to enable real-time or near real-time display and/or transmission. To improve operational efficiency (e.g., operating duration and/or power consumption) of the main encoding pipeline 48, the low-resolution pipeline 46 may include a scaler block 65 and a low resolution motion estimation (ME) block 63. The scaler block 65 may receive image data and downscale the image data (e.g., a coding unit) to generate low-resolution image data. For example, the scaler block 65 may downscale a 32×32 coding unit to one-sixteenth resolution to generate an 8×8 downscaled coding unit. In other embodiments, such as embodiments in which the pre-processing circuitry generates image data (e.g., low-resolution image data) from source image data, the low-resolution pipeline 46 may not include the scaler block 65, or the scaler block 65 may not be utilized to downscale image data.

The low resolution motion estimation block 63 may improve operational efficiency by initializing the motion estimation block 51 with candidate inter prediction modes, which may facilitate reducing searches performed by the motion estimation block 51. Additionally, the low resolution motion estimation block 63 may improve operational efficiency by generating global motion statistics that may be utilized by the motion estimation block 51 to determine a global motion vector.

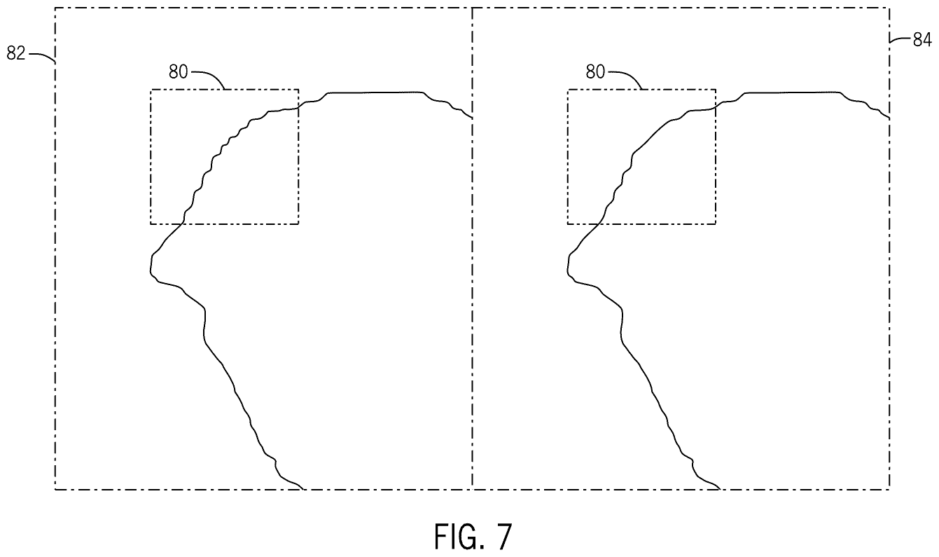

Initially, motion vectors are fully calculated at fixed intervals spaced across pixels of the image frame and the motion vectors in between these points may be obtained through interpolation. The resulting motion vector field may be used to encode the image data. By using barycentric interpolation rather than linear interpolation, the motion vector field may be much smoother, with reduced jagged edges. For example, FIG. 7 compares a region 80 from two motion vector fields-a first motion vector field 82 interpolated using linear interpolation and a second motion vector field 84 interpolated using barycentric interpolation. The region 80 in the motion vector field 82 interpolated using linear interpolation has more jagged edges than the motion vector field 84 interpolated using barycentric interpolation. As should be appreciated, using the smoother motion vector field 84 to encode image data may result in fewer jagged edges in the resulting encoded video images.

Without edge-adaptive barycentric motion vector estimation, the image artifact appearing in the region 80 could appear when the image content encoded based on the motion vector field 82 is displayed on the display 28. However, by employing edge-adaptive barycentric motion vector estimation, the image artifact may be invisible or partially invisible in the region 80 when the image content is encoded based on the motion vector field 84. After edge-adaptive barycentric motion vector estimation, the visibility of jagged edges in the region 80 may be reduce by 50%, 80%, 90%, 100%, and the like. The process for edge-adaptive barycentric motion vector estimation will be described in greater detail below.

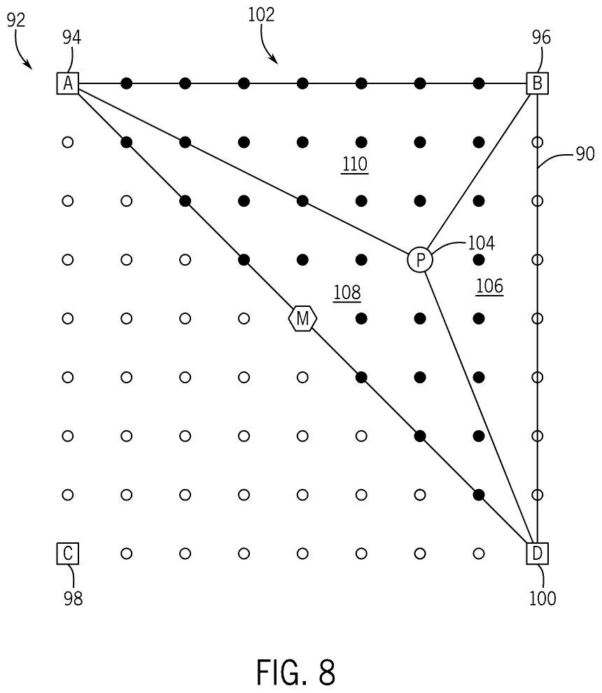

Indeed, the motion vector estimation circuitry 52 may employ barycentric motion vector estimation that may adapt based on a presence of one or more edges in image content to reduce or mitigate the image artifacts (e.g., the image artifacts in the region 80) along the one or more edges in the image content. The motion vector estimation circuitry 52 may employ barycentric interpolation when performing barycentric motion vector estimation. For example, barycentric interpolation may involve performing interpolation between four points of a polygon (e.g., square) to interpolate the motion vectors within each of two intersecting triangles within the polygon. Additional details regarding interpolation within triangles will be described below with respect to FIGS. 8-15.

FIG. 8 is an example illustration of barycentric interpolation and motion vector estimation for a top-right triangle 90, according to embodiments of the present disclosure. As described herein, barycentric interpolation may involving performing interpolation between four points of a polygon 92 to interpolate the motion vectors within intersecting triangles, such as the top-right triangle 90. For example, as illustrated in FIG. 8, the polygon 92 may include a first point 94 (e.g., point A) associated with a first motion vector, a second point 96 (e.g., point B) associated with a second motion vector, a third point 98 (e.g., point C) associated with a third motion vector, and a fourth point 100 (e.g., point D) associated with a fourth motion vector.

The motion vector estimation circuitry 52 may interpolate one or more points 102 within the top-right triangle 90. The top-right triangle 90 (e.g., triangle ABD) may be made up of the first point 94, the second point 96, and the fourth point 100. For example, the motion vector estimation circuitry 52 may interpolate a point 102 of the one or more points 102 at a spatial location 104 (e.g., point P). The motion vector estimation circuitry 52 may determine a weight (e.g., weighting factor) for each of the first point 94, the second point 96, and the fourth point 100 within the top-right triangle 90 based on each area of the triangles (e.g., sub-triangles within the triangles, triangular subsets within the triangles) that oppose (e.g., are opposite to) each of the first point 94, the second point 96, and the fourth point 100. As an example, the motion vector estimation circuitry 52 may determine the weights (e.g., weighting factors) based on a triangle 106 that opposes the first point 94, a triangle 108 that opposes the second point 96, and a triangle 110 that opposes the fourth point 100. In this manner, the motion vector estimation circuitry 52 may determine a contribution or the weight of each of the first point 94, the second point 96, and the fourth point 100 for motion vector estimation for each point 102 of the top-right triangle 90.

The triangle 106 (e.g., triangle PBD) that opposes the first point 94 may include the spatial location 104, the second point 96, and the fourth point 100. The motion vector estimation circuitry 52 may determine the weight the triangle 106 based on an area of the triangle 106. For example, the area may include one minus a horizontal phase of the triangle 106 divided by two. Thus, the area of the triangle 106 may include one minus the horizontal phase. Further, the triangle 108 (e.g., triangle PAD) that opposes the second point 96 may include the spatial location 104, the first point 94, and the fourth point 100. The motion vector estimation circuitry 52 may determine the weight of the triangle 108 based on an area of the triangle 108. For example, the area may include the horizontal phase minus a vertical phase of the triangle 106 divided by two. Therefore, the weight of the triangle 106 may include the horizontal phase minus the vertical phase.

The triangle 110 (e.g., triangle PAB) that opposes the fourth point 100 may include the spatial location 104, the first point 94, and the second point 96. The motion vector estimation circuitry 52 may determine the weight of the triangle 110 based on an area of the triangle 110. For example, the area may include the vertical phase divided by two. Thus, the weight of the triangle 110 may include the vertical phase. Therefore, the motion vector estimation circuitry 52 may determine the resulting barycentric interpolation for the motion vector of the spatial location 104 based on a summation of the motion vector at the fourth point 100 times the weight of the triangle 110, the motion vector of the second point 96 times the weight of the triangle 108, and the motion vector of the of the first point 94 times the weight of the triangle 106. It should be noted that the motion vector estimation circuitry 52 may repeat the process described herein with respect to FIG. 8 any suitable number of times to determine a motion vector for each point 102 within the top-right triangle 90. In this manner, the motion vector estimation circuitry 52 may obtain a set of barycentric interpolated values for the top-right triangle 90.

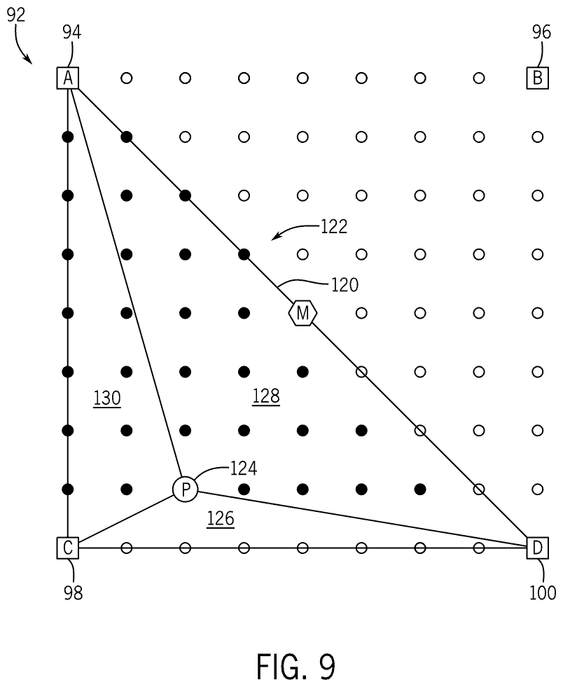

As another example, FIG. 9 is an example illustration of barycentric interpolation and motion vector estimation for a bottom-left triangle 120. As illustrated in FIG. 9, the motion vector estimation circuitry 52 may interpolate one or more points 122 at a spatial location 124 (e.g., point P). The motion vector estimation circuitry 52 may determine a weight for each of the first point 94, the third point 98, and the fourth point 100 within the bottom-left triangle 120 based on each area of the triangles that oppose each of the first point 94, the third point 98, and the fourth point 100. As an example, the motion vector estimation circuitry 52 may determine the weights based on a triangle 126 that opposes the first point 94, a triangle 128 that opposes the third point 98, and a triangle 130 that opposes the fourth point 100. In this manner, the motion vector estimation circuitry 52 may determine a contribution or weight of each of the first point 94, the third point 98, and the fourth point 100 for motion vector estimation for each point 122 of the bottom-left triangle 120.

The triangle 126 (e.g., triangle PCD) that opposes the first point 94 may include the spatial location 124, the third point 98, and the fourth point 100. The motion vector estimation circuitry 52 may determine the weight of the triangle 126 based on an area of the triangle 126. For example, the area may include one minus the vertical phase divided by two. Thus, the weight of the triangle 126 may include one minus the vertical phase. The triangle 128 (e.g., triangle PAD) may include the spatial location 124, the first point 94, and the fourth point 100. The motion vector estimation circuitry 52 may determine the weight of the triangle 128 based on an area of the triangle 128. For example, the area may include the vertical phase minus the horizontal phase divided by two. Therefore, the weight of the triangle 128 may include the vertical phase minus the horizontal phase.

The triangle 130 (e.g., triangle PAC) that opposes the fourth point 100 may include the spatial location 124, the first point 94, and the third point 98. The motion vector estimation circuitry 52 may determine the weight of the triangle 130 based on an area of the triangle 130. For example, the area may include the horizontal phase divided by two. Thus, the weight of the triangle 130 may include the horizontal phase. Therefore, the motion vector estimation circuitry 52 may determine the resulting barycentric interpolation for the motion vector of the spatial location 124 based on a summation of the motion vector at the fourth point 100 times the weight of the triangle 130, the motion vector at the third point 98 times the weight of the triangle 128, and the motion vector of the first point 94 times the weight of the triangle 126. It should be noted that the motion vector estimation circuitry 52 may repeat the process described herein with respect to FIG. 9 any suitable number of times to determine a motion vector for any number of spatial locations 124 within the bottom-left triangle 120. In this manner, the motion vector estimation circuitry 52 may obtain a set of barycentric interpolated values for the bottom-left triangle 120.

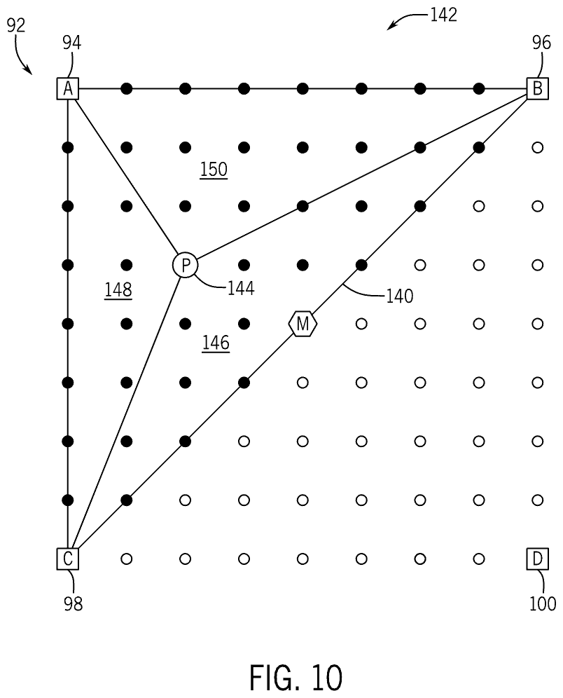

As another example, FIG. 10 is an example illustration of barycentric interpolation and motion vector estimation for a top-left triangle 140. As illustrated in FIG. 10, the motion vector estimation circuitry 52 may interpolate one or more points 142 at a spatial location 144 (e.g., point P). The motion vector estimation circuitry 52 may determine a weight for each of the first point 94, the second point 96, and the third point 98 within the top-left triangle 140 based on each area of the triangles that oppose each of the first point 94, the second point 96, and the third point 98. As an example, the motion vector estimation circuitry 52 may determine the weights based on a triangle 146 that opposes the first point 94, a triangle 148 that opposes the second point 96, and a triangle 150 that opposes the third point 98. In this manner, the motion vector estimation circuitry 52 may determine a contribution or weight for each of the first point 94, the second point 96, and the third point 98 for motion vector estimation for each point 142 of the top-left triangle 140.

The triangle 146 (e.g., triangle PBC) that opposes the first point 94 may include the spatial location 144, the second point 96, and the third point 98. The motion vector estimation circuitry 52 may determine the weight of the triangle 146 based on an area of the triangle 146. For example, the area may include one minus the horizontal phase and minus the vertical phase divided by two. Thus, the weight of the triangle 146 may include the one minus the horizontal phase minus the vertical phase. The triangle 148 (e.g., triangle PAC) may include the spatial location 144, the first point 94, and the third point 98. The motion vector estimation circuitry 52 may determine the weight of the triangle 148 based on an area of the triangle 148. For example, the area may include the horizontal phase divided by two. Therefore, the weight of the triangle 148 may include the horizontal phase.

The triangle 150 (e.g., triangle PAB) that opposes the third point 98 may include the spatial location 144, the first point 94, and the second point 96. The motion vector estimation circuitry 52 may determine the weight of the triangle 150 based on an area of the triangle 150. For example, the area may include the vertical phase divided by two. Thus, the weight of the triangle 150 may include the vertical phase. Therefore, the motion vector estimation circuitry 52 may determine the resulting barycentric interpolation for the motion vector of the spatial location 144 based on a summation of the motion vector at the third point 98 times the weight of the triangle 150, the motion vector at the second point 96 times the weight of the triangle 148, and the motion vector at the first point 94 times the weight of the triangle 146. It should be noted that the motion vector estimation circuitry 52 may repeat the process described herein with respect to FIG. 10 any suitable number of times to determine a motion vector for each point 142 within the top-left triangle 140. In this manner, the motion vector estimation circuitry 52 may obtain a set of barycentric interpolated values for the top-left triangle 140.

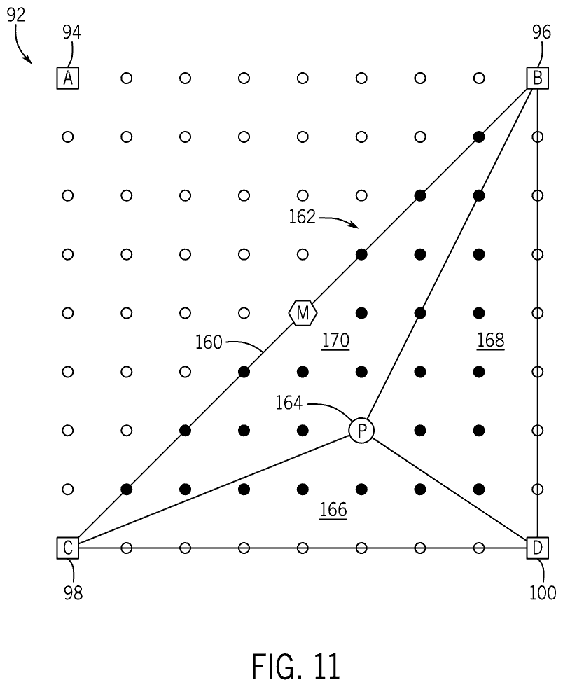

As another example, FIG. 11 is an example illustration of barycentric interpolation for a bottom-right triangle 160. As illustrated in FIG. 11, the motion vector estimation circuitry 52 may interpolate one or more points 162 at a spatial location 164 (e.g., point P). The motion vector estimation circuitry 52 may determine a weight for each of the second point 96, the third point 98, and the fourth point 100 within the bottom-right triangle 160 based on each area of the triangles that oppose each of the second point 96, the third point 98, and the fourth point 100. As an example, the motion vector estimation circuitry 52 may determine the weights based on a triangle 166 that opposes the second point 96, a triangle 168 that opposes the third point 98, and a triangle 170 that opposes the fourth point 100. In this manner, the motion vector estimation circuitry 52 may determine a contribution or weight for each of the second point 96, the third point 98, and the fourth point 100 for motion vector estimation for each point 162 of the bottom-right triangle 160.

The triangle 166 (e.g., triangle PCD) that opposes the second point 96 may include the spatial location 164, the third point 98, and the fourth point 100. The motion vector estimation circuitry 52 may determine the weight of the triangle 166 based on an area of the triangle 166. For example, the area may include one minus the vertical phase divided by two. Thus, the weight of the triangle 166 may include one minus the vertical phase. The triangle 168 (e.g., triangle PBD) that opposes the third point 98 may include the spatial location 164, the second point 96, and the fourth point 100. The motion vector estimation circuitry 52 may determine the weight of the triangle 168 based on an area of the triangle 168. For example, the area may include one minus the horizontal phase divided by two. Therefore, the weight of the triangle 168 may include one minus the horizontal phase.

The triangle 170 (e.g., triangle PBC) that opposes the fourth point 100 may include the spatial location 164, the second point 96, and the third point 98. The motion vector estimation circuitry 52 may determine the weight of the triangle 170 based on an area of the triangle 170. For example, the area may include the horizontal phase plus the vertical phase minus one to produce a value, and then the value divided by two. Thus, the weight of the triangle 170 may include the horizontal phase plus the vertical phase. As such, the motion vector estimation circuitry 52 may determine the resulting barycentric interpolation for the motion vector of the spatial location 164 based on a summation of the motion vector at the fourth point 100 times the weight of the triangle 170, the motion vector at the third point 98 times the weight of the triangle 168, and the motion vector at the second point 96 times the weight of the triangle 166. It should be noted that the motion vector estimation circuitry 52 may repeat the process described herein with respect to FIG. 11 any suitable number of times to determine a motion vector for each point 162 within the bottom-right triangle 160. In this manner, the motion vector estimation circuitry 52 may obtain a set of barycentric interpolated values for the bottom-right triangle 160.

For any given spatial point (e.g., 104, 124, 144, 164), the spatial point may occur at an intersection of at least two of the four triangles (e.g., 90, 120, 140, 160 described above with respect to FIGS. 8-11). That is, the spatial point may exist within two triangles of the four triangles. For example, one of the two intersecting triangles at a given spatial point (e.g., interpolation point) may be from the set of the top-right triangle 90 and the bottom-left triangle 120. Indeed, the top-right triangle 90 and the bottom-left triangle 120 divide into two triangles that share a common edge (e.g., point A to point D) that is spatially oriented at −45°.

Moreover, the other intersecting triangle at the given spatial point may be from the set of the top-left triangle 140 and the bottom-right triangle 160. Indeed, the top-left triangle 140 and the bottom-right triangle 160 divide into two triangles that share a common edge (e.g., point B to point C) that is spatially oriented at +45°. A relative strength of the edge of AD and the edge of BC may enable the motion vector estimation circuitry 52 to determine a weighting factor applied (e.g., assigned) to the interpolated motion vector value from each of the intersecting triangles at the given spatial point. Each of the intersecting triangles may contribute to the motion vector estimation, however, the intersecting triangle with a stronger edge may be a larger contributor to the motion vector estimation.

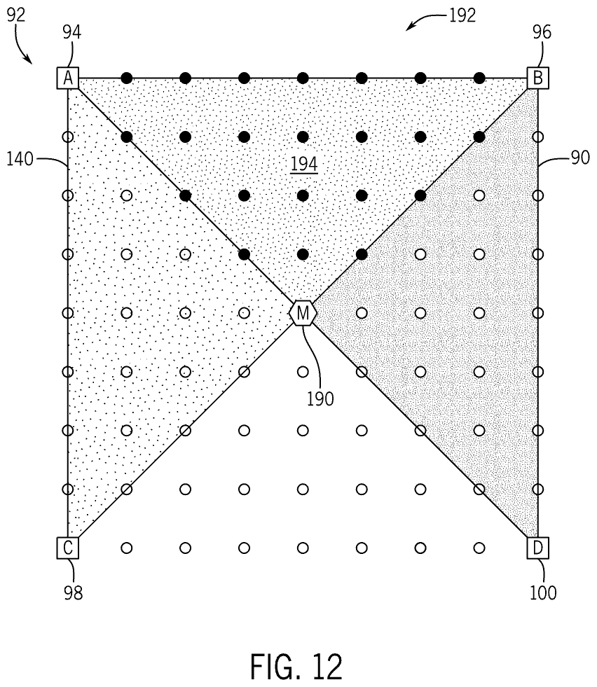

With the foregoing in mind, FIG. 12 is an example illustration of edge-adaptive barycentric interpolation for an intersection of a first triangle, such as the top-right triangle 90, and a second triangle, such as the top-left triangle 140. The polygon 92 may include a middle point 190. The motion vector estimation circuitry 52 may interpolate one or more points 192 by employing a triangle 194 (e.g., triangle MAB) that represents an intersection of the top-right triangle 90 (e.g., triangle ABD) and the top-left triangle 140 (e.g., triangle ABC). Additionally or alternatively, the middle point 190 is also interpolated using the triangle 194.

As described herein, the motion vector estimation circuitry 52 may combine (e.g., sum) the output motion vectors at each point of the intersecting triangles based on a weighting factor of the edges (e.g., dominant edges) aligned with each of the intersecting triangles. Therefore, the motion vector estimation circuitry 52 may determine a weighting factor for an edge of the top-right triangle 90 from the first point 94 to the fourth point 100 (e.g., point A to point D) oriented at (e.g., along) −45°. For example, the motion vector estimation circuitry 52 may subtract the motion vector of the fourth point 100 from the motion vector of the first point 94 to output a first value. Further, the motion vector estimation circuitry 52 may determine a weighting factor for an edge of the top-left triangle 140 from the second point 96 to the third point 98 (e.g., point B to point C) oriented at +45°. As an example, the motion vector estimation circuitry 52 may subtract the motion vector of the third point 98 from the motion vector of the second point 96 to output a second value.

The motion vector estimation circuitry 52 may then take the absolute value of the first value and the second value and compare the first value to the second value. In this manner, the motion vector estimation circuitry 52 may determine the weighting factor for the top-right triangle 90 and the weighting factor for the top-left triangle 140 based on the comparison. The motion vector estimation circuitry 52 may then determine and output the interpolated motion vectors for the triangle 194 by determining a summation of the motion vectors of the top-right triangle 90 (e.g., as described in FIG. 8) times the weighting factor of the top-right triangle 90 and the motion vectors of the top-left triangle 140 (e.g., as described in FIG. 10) times the weighting factor of the top-left triangle 140.

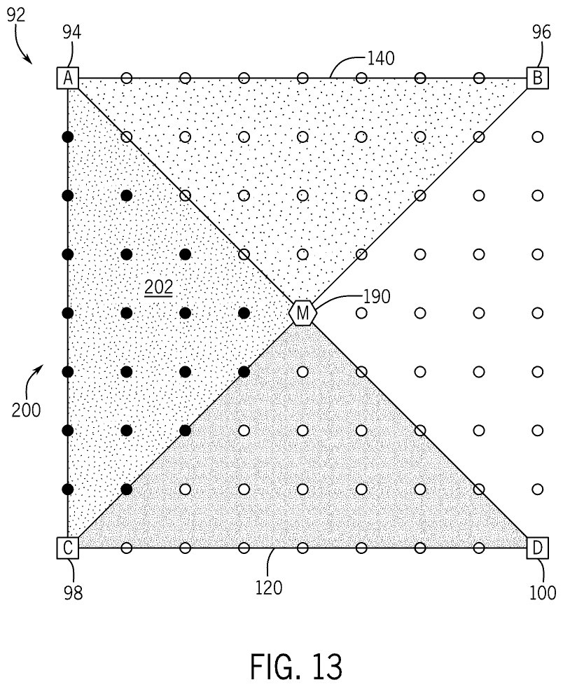

FIG. 13 is an example illustration of edge-adaptive barycentric interpolation for an intersection of the second triangle, such as the top-left triangle 140, and a third triangle, such as the bottom-left triangle 120. The polygon 92 may also include the middle point 190. The motion vector estimation circuitry 52 may interpolate one or more points 200 by employing a triangle 202 (e.g., triangle MAC) that represents an intersection of the top-left triangle 140 (e.g., triangle ABC) and the bottom-left triangle 120 (e.g., triangle ACD).

The motion vector estimation circuitry 52 may determine the weighting factor for an edge of the top-left triangle 140 from the second point 96 to the third point 98 oriented at +45°. As an example, the motion vector estimation circuitry 52 may subtract the motion vector of the third point 98 from the motion vector of the second point 96 to output a first value. The motion vector estimation circuitry 52 may also determine the weighting factor for an edge of the bottom-left triangle 120 from the first point 94 to the fourth point 100 (e.g., point A to point D) oriented at −45°. As an example, the motion vector estimation circuitry 52 may subtract the motion vector of the fourth point 98 from the motion vector of the first point 94 to output a second value.

The motion vector estimation circuitry 52 may then take the absolute value of the first value and the second value and compare the first value to the second value. In this manner, the motion vector estimation circuitry 52 may determine the weighting factor for the top-left triangle 140 and the weighting factor for the bottom-left triangle 120 based on the comparison. The motion vector estimation circuitry 52 may then determine and output the interpolated motion vectors for the triangle 202 by determining a summation of the motion vectors of the top-left triangle 140 times the weighting factor for the top-left triangle 140 and the motion vectors of the bottom-left triangle 120 times the weighting factor for the bottom-left triangle 120.

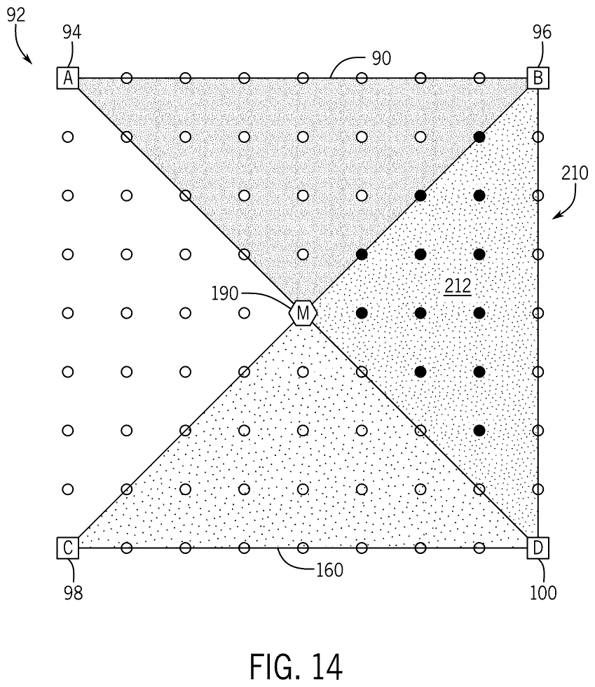

FIG. 14 is an example illustration of edge-adaptive barycentric interpolation for an intersection of the second triangle, such as the top-right triangle 90, and a fourth triangle, such as the bottom-right triangle 160. The polygon 92 may also include the middle point 190. The motion vector estimation circuitry 52 may interpolate one or more points 210 by employing a triangle 212 (e.g., triangle MBD) that represents an intersection of the top-right triangle 90 (e.g., triangle ABD) and the bottom-right triangle 160 (e.g., triangle BCD). The motion vector estimation circuitry 52 may determine a weighting factor for an edge of the top-right triangle 90 from the first point 94 to the fourth point 100 (e.g., point A to point D) oriented at (e.g., along) −45°. For example, the motion vector estimation circuitry 52 may subtract the motion vector of the fourth point 100 from the motion vector of the first point 94 to output a first value. Further, the motion vector estimation circuitry 52 may determine a weighting factor for an edge of the bottom-right triangle 160 from the second point 96 to the third point 98 (e.g., point B to point C) oriented at +45°. For example, the motion vector estimation circuitry 52 may subtract the motion vector of the third point 98 from the motion vector of the second point 96.

The motion vector estimation circuitry 52 may then take the absolute value of the first value and the second value and compare the first value to the second value. In this manner, the motion vector estimation circuitry 52 may determine the weighting factor for the top-right triangle 90 and the weighting factor for the bottom-right triangle 160 based on the comparison. The motion vector estimation circuitry 52 may then determine and output the interpolated motion vectors for the triangle 212 by determining a summation of the motion vectors of the top-right triangle 90 (e.g., as described in FIG. 8) times the weighting factor of the top-right triangle 90 and the motion vectors of the bottom-right triangle 160 (e.g., as described in FIG. 11) times the weighting factor of the bottom-right triangle 160.

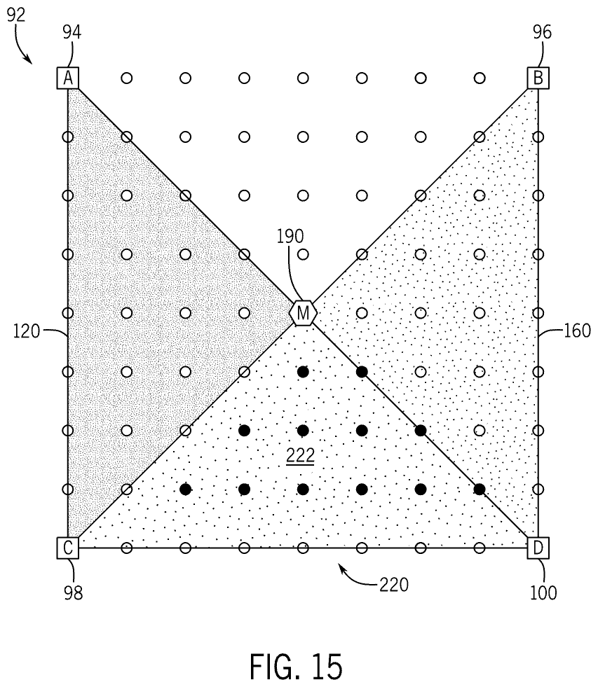

FIG. 15 is an example illustration of edge-adaptive barycentric interpolation for an intersection of the third triangle, such as the bottom-left triangle 120, and the fourth triangle, such as the bottom-right triangle 160. The polygon 92 may also include the middle point 190. The motion vector estimation circuitry 52 may interpolate one or more points 220 by employing a triangle 222 (e.g., triangle MCD) that represents an intersection of the bottom-left triangle 120 (e.g., triangle ACD) and the bottom-right triangle 160 (e.g., MBD).

The motion vector estimation circuitry 52 may determine the weighting factor for an edge of the bottom-left triangle 120 from the first point 94 to the fourth point 100 (e.g., point A to point D) oriented at −45°. As an example, the motion vector estimation circuitry 52 may subtract the motion vector of the fourth point 98 from the motion vector of the first point 94 to output a first value. The motion vector estimation circuitry 52 may also determine the weighting factor for an edge of the bottom-right triangle 160 from the second point 96 to the third point 98 (e.g., point B to point C) oriented at +45°. As an example, the motion vector estimation circuitry 52 may subtract the motion vector of the third point 98 from the motion vector of the second point 96 to output a second value.

The motion vector estimation circuitry 52 may then take the absolute value of the first value and the second value and compare the first value to the second value. In this manner, the motion vector estimation circuitry 52 may determine the weighting factor for the bottom-left triangle 120 and the weighting factor for the bottom-right triangle 160 based on the comparison. The motion vector estimation circuitry 52 may then determine and output the interpolated motion vectors for the triangle 222 by determining a summation of the motion vectors of the bottom-left triangle 120 (e.g., as determined in FIG. 9) times the weighting factor for the bottom-left triangle 120 and the motion vectors of the bottom-right triangle 160 (e.g., as determined in FIG. 11) times the weighting factor for the bottom-right triangle 160.

As such, the motion vector estimation circuitry 52 may interpolate and estimate the motion vectors for a spatial point of the polygon 92, a portion of spatial points of the polygon 92, or all of the spatial points of the polygon 92 (e.g., by employing operations performed in FIGS. 8-15). Further, the resulting motion vectors output by the motion vector estimation circuitry 52 may mitigate or reduce effects of image artifacts, such as jagged edges, that may appear in encoded image and/or video data.

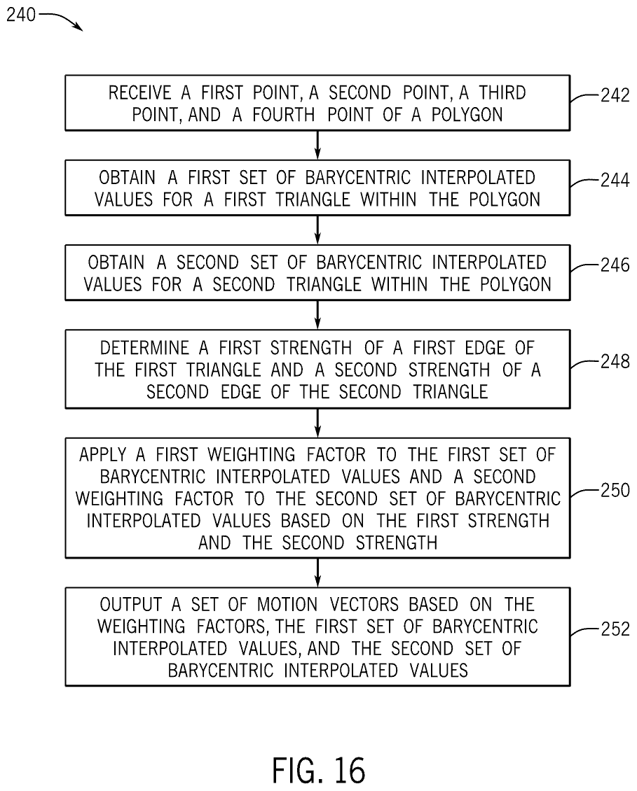

FIG. 16 is a flowchart of a method 240 for outputting a set of motion vectors based on weighting factors, a first set of barycentric interpolated values, and a second set of barycentric interpolated values. Any suitable device that may control components of the electronic device 10, such as the processor core complex 18, may perform the adjustment of the one or more pixel values. In some embodiments, the method 240 may be implemented by executing instructions stored in a tangible, non-transitory, computer-readable medium, such as the memory 20, using the processor core complex 18. For example, the processor core complex 18 may execute instructions to cause the motion vector estimation circuitry 52 to perform at least some of the steps described herein. Indeed, as an example, the method 240 may be performed by the components of the motion vector estimation circuitry 52 of the electronic device 10. As another example, the method 240 may be performed at least in part by one or more software components, such as an operating system of the electronic device 10, one or more software applications of the electronic device 10, and the like. While the method 240 is described using steps in a specific sequence, it should be understood that the present disclosure contemplates that the described steps may be performed in different sequences than the sequence illustrated, and certain described steps may be skipped or not performed altogether.

At block 242, the motion vector estimation circuitry 52 may receive the first point 94, the second point 96, the third point 98, and the fourth point 100 of the polygon 92. Further, at block 244, the motion vector estimation circuitry 52 may obtain a first set of barycentric interpolated values for a first triangle within the polygon 92. For example, as described herein, a spatial point may exist within two triangles (e.g., intersecting triangles) of four triangles within the polygon 92. Thus, the motion vector estimation circuitry 52 may obtain the first set of barycentric interpolated values for a first intersecting triangle of the intersecting triangles (e.g., such as in FIG. 8 or 9).

At block 246, the motion vector estimation circuitry 52 may obtain a second set of barycentric interpolated values for a second triangle within the polygon 92. For example, the motion vector estimation circuitry 52 may obtain the second set of barycentric interpolated values for a second intersecting triangle of the intersecting triangles (e.g., such as in FIG. 10 or 11). At block 248, the motion vector estimation circuitry 52 may determine a first strength of a first edge of the first triangle and a second strength of a second edge of a second triangle. For example, as described herein, a relative strength of the first edge of the first triangle and a relative strength of the second edge of the second triangle may enable the motion vector estimation circuitry 52 to determine a first weighting factor to apply to the first set of barycentric interpolated values and a second weighting factor to apply to the second set of barycentric interpolated values.

Thus, at block 250, the motion vector estimation circuitry 52 may apply the first weighting factor to the first set of barycentric interpolated values and the second weighting factor to the second set of barycentric interpolated values based on the first strength and the second strength. Further, at block 252, the motion vector estimation circuitry 52 may output a set of motion vectors based on the weighting factors, the first set of barycentric interpolated values, and the second set of barycentric interpolated values. For example, the motion vector estimation circuitry 52 may perform a summation of the first set of barycentric interpolated values with (e.g., multiplied by) the first weighted factor and the second set of barycentric interpolated values with the second weighting factor. It should be noted that, in some embodiments, the motion vector estimation circuitry 52 may scale the interpolated motion vectors by 2× (e.g., factor of 2), 4× (e.g., factor of 4), 8× (e.g., factor of 8), and so on.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112 (f). However, for any claims containing elements designated in any other manner, it is intended that such elements are not to be interpreted under 35 U.S.C. 112 (f).

1. An electronic device, comprising:
an image sensor to capture an image comprising image data; and
motion vector estimation circuitry, the motion vector estimation circuitry configured to:
receive a first point, a second point, a third point, and a fourth point of a polygon associated with the image data;
obtain a first set of barycentric interpolated values and a second set of barycentric interpolated values based on the polygon;
apply a first weighting factor to the first set of barycentric interpolated values;
apply a second weighting factor to the second set of barycentric interpolated values; and
output a set of motion vectors based on the first weighting factor, the second weighting factor, the first set of barycentric interpolated values, and the second set of barycentric interpolated values.

2. The electronic device of claim 1, wherein the first set of barycentric interpolated values is based on a first triangle of the polygon and the second set of barycentric interpolated values is based on a second triangle of the polygon.

3. The electronic device of claim 2, wherein the first triangle and the second triangle are intersecting triangles.

4. The electronic device of claim 2, wherein the motion vector estimation circuitry is configured to determine a first strength of a first edge of the first triangle and a second strength of a second edge of the second triangle.

5. The electronic device of claim 4, wherein the motion vector estimation circuitry is configured to apply the first weighting factor based on the first strength and the second weighting factor based on the second strength.

6. The electronic device of claim 4, wherein the motion vector estimation circuitry is configured to determine the first strength by subtracting a first motion vector of the first edge from a second motion vector of the first edge.

7. The electronic device of claim 4, wherein the motion vector estimation circuitry is configured to determine the second strength by subtracting a first motion vector of the second edge from a second motion vector of the second edge.

8. The electronic device of claim 4, wherein the first edge is oriented at −45° and the second edge is oriented at +45°.

9. The electronic device of claim 1, wherein the motion vector estimation circuitry is configured to output the set of motion vectors by combining the first set of barycentric interpolated values with the first weighting factor and the second set of barycentric interpolated values with the second weighting factor.

10. The electronic device of claim 1, wherein the motion vector estimation circuitry is configured to scale the set of motion vectors by a factor of two, a factor of four, or a factor of eight.

11. A method comprising:
interpolating, via processing circuitry, one or more first motion vectors within a first triangle based on one or more weights of one or more first points of the first triangle;
interpolating, via the processing circuitry, one or more second motion vectors within a second triangle based on one or more weights of one or more second points of the second triangle;
determining, via the processing circuitry, a first weighting factor for the first triangle;
determining, via the processing circuitry, a second weighting factor for the second triangle; and
combining, via the processing circuitry, the one or more first motion vectors with the first weighting factor and the one or more second motion vectors with the second weighting factor.

12. The method of claim 11, comprising outputting the combined set of the one or more first motion vectors and the one or more second motion vectors.

13. The method of claim 11, wherein the one or more weights of the one or more first points of the first triangle are associated with a horizontal phase, a vertical phase, or both.

14. The method of claim 11, wherein the one or more weights of the one or more second points of the second triangle are associated with a horizontal phase, a vertical phase, or both.

15. The method of claim 11, wherein the first triangle comprises an edge and the second triangle shares the edge with the first triangle.

16. One or more tangible, non-transitory computer-readable media storing instructions that, when executed by processing circuitry, are configured to cause the processing circuitry to:
determine a first weight for a first point of a triangle based on a first area of a first sub-triangle;
determine a second weight for a second point of the triangle based on a second area of a second sub-triangle;
determine a third weight for a third point of the triangle based on a third area of a third sub-triangle; and
determine a first set of barycentric interpolated values for the triangle based on the first weight, the second weight, and the third weight.

17. The one or more tangible, non-transitory computer-readable media of claim 16, wherein the first sub-triangle opposes the first point, the second sub-triangle opposes the second point, and the third sub-triangle opposes the third point.

18. The one or more tangible, non-transitory computer-readable media of claim 16, wherein the first area, the second area, and the third area are respectively associated with a vertical phase, a horizontal phase, or both.

19. The one or more tangible, non-transitory computer-readable media of claim 16, wherein the first weight, the second weight, and the third weight are respectively associated with a vertical phase, a horizontal phase, or both.

20. The one or more tangible, non-transitory computer-readable media of claim 16, wherein the first sub-triangle, the second sub-triangle, and the third sub-triangle are each associated with a spatial location.
